(19) United States
(12) Patent Application Publication
(10) Pub. No.: US 2014/0095333 A1
(43) Pub. Date: Apr. 3, 2014

(54) System and Method for Purchasing a Playlist Linked to an Event

(71) Applicant: STUBHUB, INC., San Francisco, CA (US)

(72) Inventor: Matthew Scott Zises, San Jose, CA (US)

(73) Assignee: StubHub, Inc., San Francisco, CA (US)

(21) Appl. No.: 13/629,803

(22) Filed: Sep. 28, 2012

(51) Int. Cl. G06Q 30/06

(52) U.S. Cl. 705/26.1

(57) ABSTRACT

The present disclosure involves a system and method for conducting an electronic purchasing transaction involving media items associated with an event. The system receives, from a user, a request to purchase a plurality of media items associated with an event. The event may be a sporting event or an entertainment event. The media items may be audio or video items shown at the sporting event or the entertainment event. Using one or more electronic processors, the system compiles the plurality of media items into a playlist. The playlist arranges the media items according to a sequence in which they are presented during the event. Thereafter, the system conducts an electronic purchasing transaction in which the playlist containing the media items is sold to the user.

### BACKGROUND

1. Field of the Invention

The present invention relates generally to on-line purchases, and more particularly, to purchasing a playlist of media items associated with an event.

2. Related Art

Computer systems and networks have facilitated the tasks of buying, selling and transferring goods. For example, global computer networks, such as the Internet, have allowed purchasers to relatively quickly and efficiently seek and purchase goods online. Similarly, global computer networks provide an efficient and cost-effective medium for sellers to advertise, offer, provide, and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers, and to perform other related logistics. For these reasons, sellers actively use the Internet to offer, sell and distribute a wide variety of goods to take advantage of the many benefits provided by the Internet and electronic commerce.

One example of a market for goods within the realm of electronic commerce is the online ticket. Service providers like STUBHUB® offers a network-based system which implements an online ticket marketplace for buyers and sellers of tickets for live events such as sports, concerts, theater, and other entertainment events. The STUBHUB® online ticket marketplace enables legitimate, convenient, reliable, and secure transactions at fair market value and provides ticket fulfillment services, even for “sold out” events. Accordingly, the STUBHUB® online ticket marketplace provides benefits for fans who wish to buy, sell or otherwise transfer tickets as well as for teams, artists, and venues.

However, consumers have not been able to make customized purchases of digital media associated with events such as sporting events or entertainment-related events. Therefore, a need exists to provide consumers with the ability to make customized purchases for digital media associated with certain events.

### BRIEF DESCRIPTION OF THE DRAWINGS

FIGS. 1-2 illustrate example scenarios involving an event for which a plurality of media items may be associated.

FIG. 3 is a flowchart showing a method for conducting an electronic purchasing transaction involving media items associated with an event.

FIG. 4 is a block diagram of a communications system including a network-based system for providing online marketplace and ticket fulfillment services suitable for implementing processes described herein according to one embodiment.

FIG. 5 is a block diagram of a computer system suitable for implementing one or more components in FIG. 4 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Various embodiments are described for enabling an online ticket marketplace to provide variable distribution and access control for purchased event tickets. Numerous specific details are set forth to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

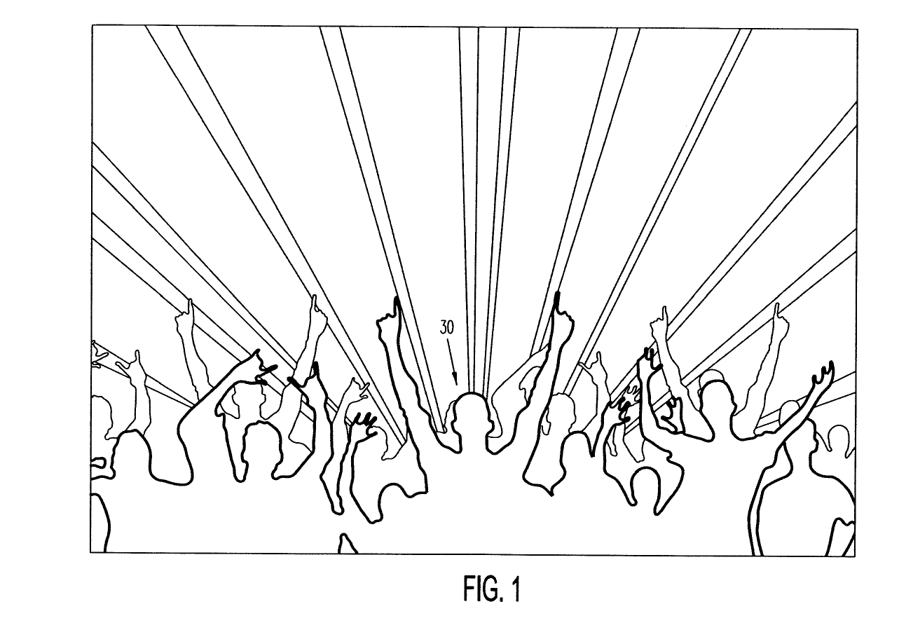

FIG. 1 is a simplified diagram illustrating an example entertainment event. In the illustrated embodiment, the entertainment event is a concert. In other embodiments, the entertainment event may be a film festival, a musical recital, a debate, a play, a standup comedy routine, a circus act, a magic show, or another live performance. The entertainment event is attended to by a plurality of users, such as a user 30. The user 30 may have purchased the ticket to the entertainment event through an online ticket marketplace such as STUBHUB® or through an agency such as TICKETMASTER®.

As the user 30 listens to the concert, he may be able to “tag” each song through audio/video recognition and identification application such as SHAZAM®. In more detail, the audio/video recognition and identification application may be downloaded and installed as an application (“app”) in a portable electronic device of the user. The portable electronic device may be a mobile phone (e.g., a smart-phone) or a tablet computer, for example. The user 30 may use the audio/video recognition and identification application to “listen” to the song being played at the concert. The audio/video recognition and identification application captures a sample of the song and matches the sample to a song stored in a database or library. Once a match is found, the audio/video recognition and identification application can display information regarding the song to the user 30. Such information may include, but is not limited to: name of the song, name of the album containing the song, performer of the song, a link to a service provider's website to purchase the song, lyrics of the song, etc. This process in which the song is identified may be referred to as a tagging process.

Once a song is tagged, the user 30 now has access to the relevant information regarding the song and may purchase a copy of the song if he/she so wishes. It is understood that in other embodiments where the entertainment event is based on video, the audio/video recognition and identification application may tag various portions the video in a similar fashion. For example, if the entertainment event is an indie film festival, the audio/video recognition and identification application may be used to “tag” the vignettes being shown, which would give the user 30 information on the tagged vignettes and the ability to purchase them.

The tagging functionality provided by the audio/video recognition and identification application offers benefits for the user 30. For example, if the user 30 enjoyed a song but had not previously known what the song was, he/she may now find out more about the song and can purchase the song using the tagging process discussed above. Nevertheless, conventional tagging processes similar to that discussed above still have limitations. One limitation is that the user 30 must buy each song (or other types of tagged medium items) one at a time. Using the concert scenario of FIG. 1 as an example, if the user 30 enjoys almost every song played at that concert, he/she may need to manually tag every song, and thereafter purchase these songs on a piecemeal basis—one song purchase at a time. This is a time-consuming and tedious process.

Furthermore, sometimes the user 30 really enjoys his experience at the concert and hence wants to re-create or duplicate the experience. To do so, the user 30 may wish to create a playlist of the songs played at the concert, where the playlist arranges the songs in the same order or sequence in which they were played at the concert. However, current tagging or media purchasing services do not offer this functionality. Therefore, the user 30 would have to not only tag and purchase each song individually, but he/she also needs to create a playlist and manually configure the playlist so that all the songs are played according to the particular sequence in which they were played at the concert. Once again, this is a cumbersome process and may frustrate the user 30.

To overcome these problems, the present disclosure offers a system and method for automatically compiling and purchasing a playlist of media items associated with an event. Using the same scenario discussed above as an example, suppose the user 30 wants to re-create his/her experience at the concert in as an authentic manner as possible. Thus, the user 30 can still individually tag the songs played at the concert. After the concert is finished, the user 30 may then submit the entire list of songs tagged at the concert to a media service provider for purchase.

According to the various aspects of the present disclosure, the media service provider will create a playlist that contains the songs submitted by the user 30. In some embodiments, the playlist will arrange the songs in a chronological order in which they were tagged. For example, if a song A is tagged before a song B, and the song B is tagged before a song C, then the playlist will arrange the songs in the order of A=>B=>C. In this manner, when the playlist is played, the song A will be played first, and then the song B, and then the song C. This arrangement of the songs closely duplicates the user experience at the concert, because the chronological order in which the songs are tagged generally corresponds to the order in which they were played at the concert as well. Now, when the user 30 buys the songs, he/she can buy them collectively in “one fell swoop” via purchasing the playlist. In addition, since the playlist is configured so that the songs are played according to the sequence at which they were presented at the concert, the user 30 may be able to re-create his/her experience at the concert.

In another embodiment, the user 30 need not tag each song. Instead, the system of the present disclosure still works even if the user 30 tags just a few songs. The system—which may include some type of media recognition and identification capabilities of its own—will perform an analysis on the tagged songs. Based on results returned by the tagging process, the system may perform the analysis using one or more of the following: the names of the songs tagged, the artists performing the songs, the sequence at which the songs are tagged, the respective times at which the songs are tagged, and the concerts occurring at the time the songs are tagged.

After running the analysis, the system may be able to determine which concert the user 30 is attending when he/she tagged those songs. The system may optionally ask the user 30 to verify that he/she is (or was) indeed at the concert for additional confirmation. The system will then automatically compile a playlist of all the songs played during the concert. The playlist is compiled such that the songs in the playlist will appear in the specific order in which they were played during the concert.

With a single transaction, the user 30 may once again purchase the entire playlist with the songs arranged in the specific order. In this embodiment, the system of the present disclosure simplifies the tasks that the user 30 needs to perform, because the user 30 now only needs to tag a subset of the songs played at the concert, as opposed to having to tag all of them. Furthermore, the user 30 may be able to skip the step of having to submit the tagged song to the system for purchase. Instead, the system of the present disclosure may allow the user 30 to purchase the playlist associated with the concert once the concert has been identified by the analysis discussed above, even if the user 30 has not submitted any purchasing requests. In other words, after tagging several songs, the user 30 may be prompted with a message such as, “It appears that you are at EXAMPLE CONCERT A. If so, would you like to buy the entire playlist of songs for this concert?” or another similar message.

For some types of events, the system of the present disclosure allows a non-attendee or a non-special guest to purchase a certain playlist associated with the event, but the system may also allow an attendee or a special guest to purchase a different playlist. For example, a person who did not attend a concert may have the option of purchasing a playlist containing regular versions of songs (e.g., album version) played at the concert. Meanwhile, a person who actually attended the concert may be given the option to choose between purchasing the playlist containing the regular version of songs, or another playlist containing live versions of the songs played at the concert. Also, a special guest, for example a guest with a VIP pass, may be able to purchase a special playlist with additional media content. For example, the special playlist may include a band's rehearsal music, one or more bonus tracks, or exclusive backstage interviews with band members, etc. In order for the purchaser to gain access to these playlists, the system may require the purchaser to go through an additional level of confirmation. For example, the additional level of confirmation may involve scanning in a VIP pass, verifying a secret password (e.g., a password known only to these special guests), or sending/retrieving a locational signal generated from a personal electronic device of the guest. The availability of different types of playlists to different types of guests may help upsell an exclusive event, since the restricted access to these special playlists may enhance the perceived value of the event.

In yet other embodiments, the system of the present disclosure may further simplify matters for the user 30 by allowing the user 30 to directly supply information related to the concert. In one example, the system may prompt the user 30 to enter the date, location, and the artist performing the concert. This information may be supplied by the user 30 well after the concert has been performed. Based on this information, the system may look up the concert and determine what songs (and in what order) were played at the concert. The system may then compile the playlist containing the songs in the same order they were presented at the concert, and the user 30 may be able to buy all the songs in playlist with a single transaction.

In another example, if the user 30 had actually bought a ticket to attend the concert, the user 30 may be able to simply supply the ticket information to the system of the present disclosure. The ticket information may include a unique identifier such as a scan-able code or an alphanumeric number. The system of the present disclosure may offer a user interface in which the user 30 can directly type in the unique identifier, or to have the identifier scanned by an imaging device (such as a camera on a mobile phone or tablet computer). Once the system retrieves the ticketing information provided by the user 30, the system may once again determine the songs (and their order) that need to appear on the playlist. The system can then offer such playlist to the user to purchase with a single transaction.

In the above examples, the order of the songs in the playlist may be dependent on the location at which the concert was performed. This is because the performers of the concert may not necessarily play the songs in the same order at different locations where the concert is held. As an example, the performers may perform the songs in the order of A=>B=>C=>D in a concert held in Dallas, Tex., but they may perform the same songs in the order of B=>A=>D=>C in Atlanta, Ga. Thus, the system of the present disclosure will take into account of the location of the concert and make sure that the order of the songs in the playlist follows the order in which these songs were played at that particular location. Similarly, the order of the songs in the playlist may also depend on the date (or time) of the concert as well. This is because the performers may decide to play the songs in different orders at two or more concerts held at different times, even if they were all held in the same location.

In some embodiments, once the playlist containing all the songs of a concert is offered to the user 30 for purchase, the user 30 need not be forced to buy the entire playlist, but instead may elect to purchase a subset of the playlist. For example, if the user 30 enjoyed 15 out of 18 songs played at a concert, and the playlist contains all 18 songs, the user 30 may elect to buy only the 15 songs that he/she enjoyed. In some cases, the user may receive a discount for buying a subset of the playlist. The songs in the subset of the playlist purchased by the user 30 may still be arranged in the same order they were played during the concert.

In more embodiments, if the user 30 wishes, the system may also allow the user to manually compile a list of songs that he/she would like to purchase. The user may compile the list by supplying the name of the songs or by doing a search involving one or more attributes of the song such as its name, album, year released, artist, genre, etc. The user may be able to specify the order in which the songs should be played in the playlist. The songs may or may not all originate from a single event. Also, the order of the songs may or may not correspond to the order in which they were presented at the event. In other words, some aspects of the present disclosure may be broad enough to cover situations where the user 30 simply wants to create and purchase a playlist having a specified order of songs in a single transaction.

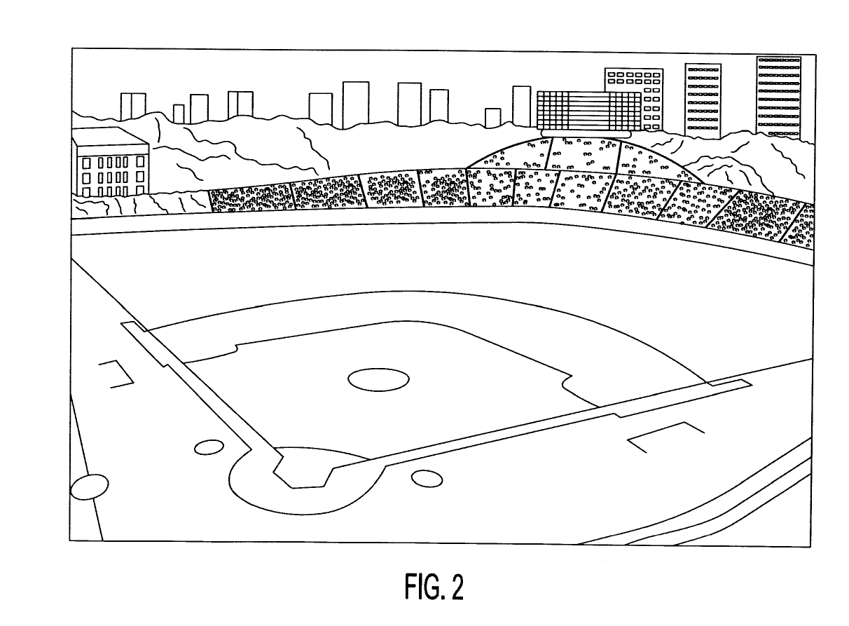

Though the discussions above utilized songs played at a concert as example media items associated with an event to illustrate the various concepts of the present disclosure, it is understood that the same concepts may apply to other types of events or their associated media items. For example, FIG. 2 illustrates a sporting event, specifically, a baseball game in which the user 30 (not shown in FIG. 2) attends. In the example context of a baseball game, when a batter comes to the plate to bat, a particular “walk-up” song is played. Different batters may have their own walk-up songs, and each batter may also specify a different walk-up song to be played for each game.

As a baseball fan, the user 30 may relish the particular game he/she attends (especially if it is an important win for the user's team, for example in a crucial playoff game). In order to “relive” the win, the user 30 may wish to create a playlist of all the “walk-up” songs played at the game, and where the songs should be played in the same order corresponding to when the batters walked up to the plate to bat. Again, whereas conventional systems and services do not offer an easy way for the user 30 to accomplish this task, the system of the present disclosure is capable of automatically compiling and let the user 30 purchase a customizable playlist with the songs arranged in a specific order set by the user 30. Similar to the case with the concert, the user 30 may specify the baseball game (i.e., the teams playing the game and the date the game is played) manually or simply send the system of the present disclosure the ticketing information of the baseball game. The user 30 may also tag all the walk-up songs or a subset thereof, or manually submit a list of songs to the system of the present disclosure.

Once the system identifies the particular game based on the information supplied by the user, the system may determine what songs were played at the game and may automatically compile the playlist accordingly. As a default, the songs may be arranged according to the order at which they were played during the game. However, if the user 30 wishes to adjust the order of the songs on the playlist, he/she may also be allowed to specify a different order as well. In this manner, the user 30—as a baseball fan—may be able to “relive” the game, since the songs played in the specific order on the playlist will help conjure up memories of the baseball game.

In the example context of the baseball game discussed above, typically only the walk-up songs from the home team are played during the game. However, if the user 30 wishes to purchase the walk-up songs for the visiting team (which are typically not played) instead of, or in addition to, the walk-up songs from the home team, the system may give the user 30 the option to do so. For example, the user 30 may be living in Boston, but he is a fan of the New York Yankees. When the Yankees are visiting Boston to play the Red Sox, the user 30 may choose to buy a playlist of the walk-up songs for the Red Sox on that day, or a playlist of walk-up songs often played for the batters on the Yankees' team, or a combined playlist where the walk-up songs from both teams are included. The walk-up songs from both teams may be combined either on an inning-to-inning basis, or according to a sequence where the songs from one team are all played before the songs from the other team are played. Also, the user 30 may be able to specify which songs should be included in the playlist for the visiting team. As one example, the user 30 may specify the visiting team's playlist to include songs from a previous game—where the visiting team was the home team. As another example, the user 30 may ask the system to survey the different walk-up songs for each batter, and automatically select the most popular song for that batter (i.e., the most representative walk-up song for that batter) as the song to include in the playlist.

Again, the concert and baseball game illustrated in FIGS. 1-2 are merely examples and are not meant to limit the scope of the present disclosure. The various concepts discussed above may apply to other types of events for which media items (audio or video, or both) can be associated. For instance, these other events may include film festivals, musical recitals, debates, plays, standup comedy routines, circus acts, magic shows, or other types of live performances.

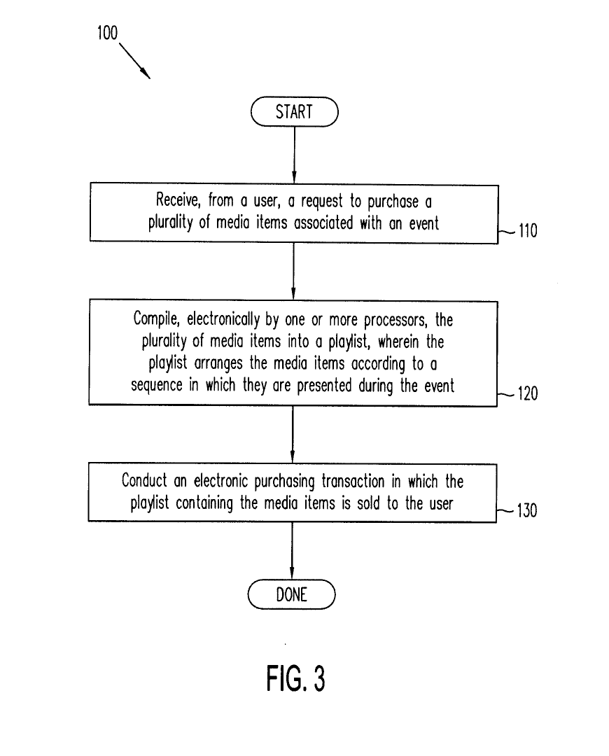

FIG. 3 is a flowchart showing a method 100 of conducting an electronic purchasing transaction involving media items associated with an event. In some embodiments, the method 100 is performed by a ticket provider or a service provider.

The method 100 includes a step 110, in which a request to purchase a plurality of media items is received. In some embodiments, the request is received from a user. The media items are associated with an event, such as a sporting event or an entertainment event. In some embodiments, the media items include music (such as songs) or videos played during the event. In some embodiments, the step 110 includes receiving a plurality of tags that each correspond to a respective one of the media items. The plurality of tags may be a subset of the playlist. In some other embodiments, the step 110 includes receiving identification information specifying the event in which the media items are played. The identification information may include the ticketing information for the event. The identification information may also include information regarding time, location, name, and performers for the event.

The method 100 includes a step 120, in which the plurality of media items are compiled into a playlist via one or more electronic processors. The playlist arranges the media items according to a sequence in which they are presented during the event. In some embodiments, the playlist may be determined in its entirety based on the tags submitted by the user in step 110.

The method 100 includes a step 130, in which an electronic purchasing transaction is conducted, in which the playlist containing the media items is sold to the user. It is understood that additional steps may be performed before, during, or after the steps 110-130 discussed above. For example, after the playlist is compiled and before the electronic purchasing transaction is conducted, the method 100 may include a step in which the user is authenticated, and a confirmation is sent to the user asking the user to verify the purchase. However, for reasons of simplicity, the other steps are not illustrated or discussed in detail herein.

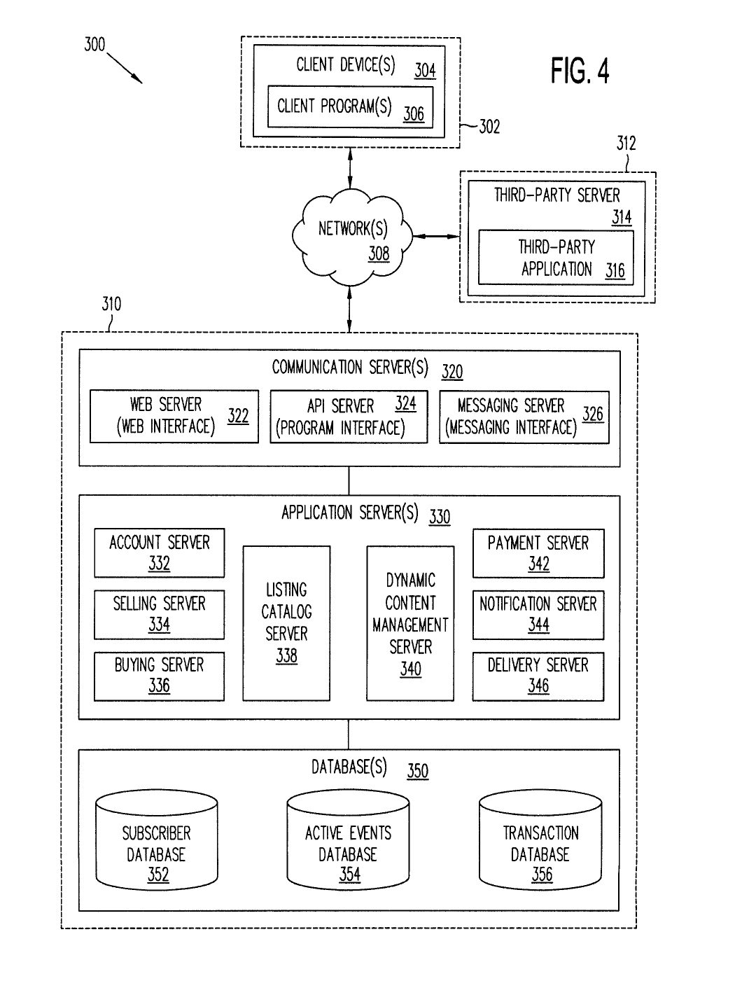

FIG. 4 illustrates a communications system 300 suitable for implementing various embodiments of the present disclosure. The elements of communications system 300 generally may comprise physical or logical entities for communicating information and, in some cases, may be implemented as hardware, software, or combination thereof, as desired for a given set of design parameters or performance constraints. Although FIG. 4 includes a limited number of elements for purposes of illustration, it can be appreciated that communications system 300 may include more or less elements as well as other types of elements.

Various elements of communications system 300 may be implemented utilizing one or more computing devices having computing and/or communications capabilities in accordance with the described embodiments. Exemplary computing devices may include, without limitation, a mobile device, a personal digital assistant (PDA), a mobile computing device, a communications device, a telephone, a mobile telephone, a cellular telephone, a smart phone, a handset, a one-way pager, a two-way pager, a messaging device, a computer, a personal computer (PC), a desktop computer, a work station, a laptop computer, a notebook computer, a tablet computer, a handheld computer, a mini-computer, a network appliance, a web appliance, a server, a server computer, a server array, a server farm, an Internet server, a web server, a network server, a main frame computer, a supercomputer, a distributed computing system, multiprocessor system, processor-based systems, a control system, consumer electronic equipment, a media device, a gaming device, a television, a digital television, a set-top box (STB), wireless access point, base station, subscriber station, mobile subscriber center, radio network controller, a network access device, a telephone network device, a mobile telephone network device, a VoIP network device, a radio network device, a television network device, a satellite network device, a router, a hub, a gateway, a bridge, a switch, a machine, or combination thereof.

The computing devices utilized by communications system 300 may be implemented by various hardware and/or software components in accordance with the described embodiments. Exemplary hardware components may include processing devices such as central processing unit (CPU) and/or other processors, microprocessors, application processors, radio processors, baseband processors, digital signal processors (DSP), circuits, circuit elements (e.g., transistors, resistors, capacitors, inductors, and so forth), integrated circuits, application specific integrated circuits (ASIC), programmable logic devices (PLD), a field programmable gate array (FPGA), logic gates, registers, semiconductor device, chips, microchips, chip sets, memory such as volatile and/or non-volatile memory, a display such as a liquid crystal display (LCD) or cathode ray tube (CRT), input devices such a keyboard, mouse, stylus, touch pad, and/or touch screen, networking devices such as ports, network interface cards (NICs), transmitters, receivers, transceivers, and/or antennas, as well as other components. Exemplary software components may include computer programs, applications, application programs, system programs, operating system (OS) software, middleware, firmware, a software interface, a programmatic interface, an application program interfaces (API), a network interface, a web interface, a messaging interface, modules, instruction sets, routines, subroutines, functions, calls, computing code, or combination thereof.

Various elements of communications system 300 may support wired and/or wireless communications functionality in accordance with the described embodiments. For example, some computing devices may be arranged to communicate information over one or more types of communication links such as a wire, cable, bus, printed circuit board (PCB), backplane, switch fabric, semiconductor material, twisted-pair wire, co-axial cable, fiber optic connection, Ethernet connection, peer-to-peer (P2P) connection, a data channel, a radio channel, a satellite channel, a television channel, a broadcast channel, an infrared (IR) channel, a radio-frequency (RF) channel, a portion of the RF spectrum, one or more licensed or license-free frequency bands, and so forth.

Various elements of communications system 300 may support communication over one or more types of networks in accordance with the described embodiments. For example, some computing devices and networks may support communications over a Wide Area Network (WAN), the Internet, a telephone network (e.g., analog, digital, POTS, PSTN, ISDN, xDSL), a mobile telephone network (e.g., CDMA, GSM, LTE, WIMAX, NDAC, TDMA, E-TDMA, NAMPS, WCDMA, CDMA-2000, UMTS, 3G, 4G), a radio network, a television network, a cable network, an optical network (e.g., PON), a satellite network (e.g., VSAT), a packet-switched network, a circuit-switched network, a public network, a private network, and/or other wired or wireless communications network configured to carry data. Computing devices and networks also may support wireless wide area network (WWAN) communications services including Internet access such as EV-DO, EV-DV, CDMA/1xRTT, GSM/GPRS, EDGE, HSDPA, HSUPA, and others.

Computing devices and networks may support wireless local area network (WLAN) and/or wireless metropolitan are network (WMAN) data communications functionality in accordance with Institute of Electrical and Electronics Engineers (IEEE) standards, protocols, and variants such as IEEE 802.11 (“WiFi”), IEEE 802.16 (“WiMAX”), IEEE 802.20x (“Mobile-Fi”), and others. Computing devices and networks also may support short range communication such as a wireless personal area network (WPAN) communication, Bluetooth® data communication, infrared (IR) communication, near-field communication, electro-magnetic induction (EMI) communication, passive or active RFID communication, micro-impulse radar (MIR), ultra-wide band (UWB) communication, automatic identification and data capture (AIDC) communication, and others.

Further aspects and advantages of various embodiments will become more readily appreciated and better understood by the following description of the elements of communications system 300 illustrated in FIG. 4. Although certain exemplary embodiments and implementations may be illustrated and described as comprising a particular combination of elements and performing a particular set of operations, it is to be understood that the principles and techniques discussed herein are not limited to such examples.

In the embodiment shown in FIG. 4, communications system 300 includes, among other elements, a client 302 which may comprise or employ one or more client devices 304 such as a mobile computing device, a PC, and/or any other computing device having computing and/or communications capabilities in accordance with the described embodiments. Client devices 304 generally may provide one or more client programs 306 such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. In some usage scenarios, one or more of client programs 306 may display various graphical user interfaces (GUIs) to present information to and/or receive information from one or more of client devices 304.

As shown, client 302 is communicatively coupled via one or more networks 308 to a network-based system 310. Network-based system 310 may be structured, arranged, and/or configured to allow client 302 to establish one or more communications sessions with network-based system 310 using various computing devices 304 and/or client programs 306. Accordingly, a communications session between client 302 and network-based system 310 may involve the unidirectional and/or bidirectional exchange of information and may occur over one or more types of networks 308 depending on the mode of communication. While the embodiment of FIG. 4 illustrates communications system 300 deployed in a client-server operating environment, it is to be understood that other suitable operating environments and/or architectures may be used in accordance with the described embodiments.

Data and/or voice communications between client 302 and the network-based system 310 may be sent and received over one or more networks 308 such as the Internet, a WAN, a WWAN, a WLAN, a mobile telephone network, a landline telephone network, a VoIP network, as well as other suitable networks. For example, client 302 may communicate with network-based system 310 over the Internet or other suitable WAN by sending and or receiving information via interaction with a web site, e-mail, IM session, and/or video messaging session. Client 302 also may communicate with network-based system 310 via a telephone call to a customer service agent and/or interactive voice response (IVR) system made over a mobile telephone network, a landline network, and/or a VoIP network. In wireless implementations, client 302 may communicate with network-based system 310 over the Internet via a WLAN or mobile telephone network that supports WWAN communications services. Client 302 also may communicate over a mobile telephone network via SMS and/or MMS messaging. It is to be appreciated that the embodiments are not limited in this regard.

In various usage scenarios, communication sessions and/or messaging between client 302 and network-based system 310 may involve multiple modes of communication and/or multiple networks. In some cases, for example, client 302 may initiate communication with network-based system 310 by interacting with a web site. In response, network-based system 310 may communicate with client 302 in a variety of ways such as via the web site, e-mail, IM, SMS, MMS, and/or a telephone call from a customer service agent and/or IVR system. The communication from network-based system 110 may comprise a message (e.g., e-mail, IM, SMS, MMS) containing relevant static or dynamic content, an embedded hyperlinked URL for directing client 302 to a web site, and/or a hyperlinked telephone number for allowing client 302 to click and place a telephone call to an agent (e.g., customer service agent and/or IVR system) of network-based system 310.

When communicating with network-based system 310, client 302 may employ one or more client devices 304 and/or client programs 306. In various implementations, client devices 304 and/or client programs 306 may host or provide one or more interfaces for communicating with network-based system 310. Exemplary interfaces may include a web interface, an API interface, a messaging interface, and/or other suitable communication interface in accordance with the described embodiments. Client programs 306 for communicating with network-based system 310 may comprise, for example, pre-installed, authored, downloaded, and/or web-based computer programs.

Client programs 306 provided by one or more of client devices 304 (e.g., mobile computing device and/or PC) may include a web client. The web client may comprise, for example, a desktop and/or mobile (e.g., WAP) web browser (e.g., Internet Explorer®, Mozilla®, Firefox®, Safari®, Opera®, Netscape Navigator®, etc.) capable of rendering web pages (e.g., HTML documents) and supporting various browser-based web technologies and programming languages such as HTML, XHTML, CSS, Document Object Model (DOM), XML, XSLT, XMLHttpRequestObject, JavaScript, ECMAScript, Jscript, Ajax, Flash®, Silverlight™, Visual Basic® (VB), VB Scripting Edition (VBScript), PHP, ASP, Java®, Shockwave®, Python, Perl®, C#/.net, and/or others.

In various usage scenarios, client 302 may use a web client to provide an interface (e.g., HTTP interface) for navigating to a web site associated with network-based system 310 and for requesting and receiving web page data from network-based system 310. For example, client 302 may use the web client to navigate to a web site associated with network-based system 310 by entering a URL into a web browser address bar and/or by clicking on a hyperlinked URL delivered to client 302 via a web page, web-based application, e-mail, IM, SMS, MMS, and/or other delivery mechanism.

In one or more embodiments, the web client may comprise or be implemented as a web browser toolbar for communicating with network-based system 310. In such embodiments, the web browser toolbar may include, for example, a button (e.g., dedicated, customized, add-on) and/or a hyperlinked URL for navigating to a web site associated with network-based system 310. The web browser toolbar also may implement enhanced features such as a search engine interface (e.g., text entry box, input fields, checkboxes, clickable hyperlinks) and/or one or more pull-down menus for accessing network-based system 310, sending information (e.g., search query, keywords, user preferences, menu selections) to network-based system 310, and/or receiving information (e.g., search results, relevant static or dynamic content) from network-based system 310.

In one or more embodiments, the web client may comprise or be implemented as a widget such as a desktop or mobile widget for communicating with network-based system 310. In such embodiments, the desktop or mobile widget may comprise web-based code, an interpreter, a virtual machine, and/or an API implementation to request, receive, present, and/or update content hosted by network-based system 310. The desktop or mobile widget may comprise, for example, a client-side web application displayed on the desktop or phone-top of one or more of client devices 304 implemented using various web technologies and programming languages. In various implementations, the desktop or mobile widget may be supported by a host runtime environment such as a web browser or suitable rendering engine and/or may be installed and run as a stand-alone application outside of a web browser.

In various embodiments, the network-based system 310 may provide users with one or more client-side web applications as described in co-pending U.S. patent application Ser. No. 12/275,783 titled “System and Methods for Providing Location-Based Upcoming Event Information Using a Client-Side Web Application Implemented on a Client Device,” which was filed on Nov. 21, 2008 and is incorporated by reference in its entirety. In such embodiments, once downloaded and installed on a client device (e.g., PC or mobile device) of the user, the client-side web application may be configured to provide upcoming event information based upon the location of the user.

As shown in FIG. 4, communications system 300 includes, among other elements, a third party 312 which may comprise or employ a third-party server 314 hosting a third-party application 316. In various implementations, third-party server 314 and/or third-party application 316 may host a web site associated with or employed by a third party 312 such as an affiliate, partner, or other third-party entity or user in accordance with the described embodiments. It can be appreciated that, in some implementations, third party 312 may provide third-party application 316 for promoting, enhancing, complementing, supplementing, and/or substituting for one more services provided by network-based system 310. For example, third-party server 314 and/or third-party application 316 may enable network-based system 310 to provide client 302 with additional services and/or information such as additional ticket inventory.

In some usage scenarios, one or more of client programs 306 may be used to access network-based system 310 via third party 312. For example, client 302 may use a web client to access and/or receive content from network-based system 310 after initially communicating with a third-party web site. The web site of third party 312 (e.g., affiliate, partner) may comprise, for example, a hyperlinked advertisement, a web widget, and/or an API implementation comprising web-based code within a web page to present static or dynamic content hosted by network-based system 310 and/or to provide programmatic access to network-based system 310.

It can be appreciated that the hyperlinked advertisement, web widget, and/or API implementation for communicating with network-based system 310 may be hosted by various third-party web sites such as an affiliate web site, a partner web site, an online marketplace web site, an entertainment web site, a sports web site, a media web site, a search engine web site, a social networking web site, a blog, and/or any other corporate or personal web site or web page in accordance with the described embodiments. In some cases, third party 312 may be directly or indirectly compensated for directing traffic from the third-party web site to the web site of network-based system 310 and/or in the event that an electronic commerce transaction results after a user is directed from the third-party web sites to the web site of network-based system 310.

In various embodiments, the web client and/or the network-based system 310 may provide the user with the ability to receive and aggregate content and/or online marketplace and ticket fulfillment services of network-based system 310 and other third-party services (eBay® services, Kijiji™ services, PayPal™ services, etc.). For example, the web client may display location-based upcoming event information that includes event listings published by sellers via the online marketplace services of network-based system 310 as well as event listings published by sellers via one or more third-party online marketplace services (e.g., eBay® services, Kijiji™ services). In such embodiments, the client-side web application may display an aggregate of ticket inventory available from multiple online marketplaces providing the user with multiple purchasing options.

Client programs 306 executed by one or more of client devices 304 may include a programmatic client for accessing and communicating with network-based system 310. Along with performing a certain set of functions, the programmatic client may include, for example, an implementation of an API provided by network-based system 310 for enabling access to and/or communication with various elements (e.g., servers, databases) of network-based system 310. In various embodiments, the API implementation may comprise executable code in accordance with an SDK provided by network-based system 310.

In some usage scenarios, the programmatic client may be implemented as a stand-alone or web-based database, point-of-sale (POS), and/or inventory management application for managing a large volume of available inventory and communicating with network-based system 310. The programmatic client may be employed, for example, by high-volume sellers to author, update, and manage a large number of inventory listings. In some cases, a high-volume seller may use the programmatic client to perform batch-mode communication with network-based system 310. The batch-mode communication from the high-volume seller may comprise data for numerous inventory items (e.g., hundreds, thousands) for publication by network-based system 310. The programmatic client also may be used to communicate with the network-based systems in real-time. For example, communications from the high-volume seller may comprise real-time inventory updates so that the listings published by network-based system 310 accurately reflect the available inventory of the high-volume seller.

Client programs 306 executed by one or more of client devices 304 (e.g., mobile computing device and/or PC) also may include a messaging client. The messaging client may comprise, for example, an application that supports one or more modes of communication such as e-mail, IM, SMS, MMS, telephone, VoIP, video messaging, and so forth. It can be appreciated that some messaging clients may required and/or launch an Internet connection in the background when executed.

In accordance with various embodiments, network-based system 310 may communicate with and provide services to users such as buyers and/or sellers of goods such as event tickets. For example, network-based system 310 may comprise or implement an online ticket marketplace for buyers and sellers of tickets for live events such as sports, concerts, theater, and other entertainment events.

It is to be appreciated that goods for purchase and/or sale may include both tangible goods (e.g., physical tickets, electronic tickets), intangible goods (e.g., rights and/or licenses that are afforded by the tickets), and other goods in accordance with the described embodiments. It also is to be appreciated that users other than buyers and/or sellers may communicate with network-based system 310. In some cases, for example, client 302 may be associated with an administrator or customer service agent and may communicate with network-based system 310 to monitor, update, and/or otherwise manage one or more computing devices and/or services of network-based system 310.

FIG. 4 illustrates an exemplary embodiment of network-based system 310 for providing online ticket marketplace. As shown, network-based system 310 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 4 may be deployed in other ways and that the operations performed and/or the services provided by such servers may be combined or separated for a given implementation and may be performed by a greater number or fewer number of servers. One or more servers may be operated and/or maintained by the same or different entities.

In various implementations, the servers of network-based system 310 may comprise or implement software components deployed in a tiered environment, where one or more servers are used to host server software running in each tier. For example, using a three-tiered architecture, one or more server software components may be hosted by front-end servers, one more server software components may be hosted by a middle tier or middleware implemented by application servers, and one more server software components may be hosted by a back-end tier implemented by databases and/or file systems. In some embodiments, servers of network-based system 310 may be communicatively coupled with each other via a local area network (LAN) and/or suitable intranet or back-end network.

Network-based system 310 may comprise one or more communications servers 320 for providing suitable interfaces to enable communication using various modes of communication and/or via one or more networks 308. In the embodiment of FIG. 4, the communications servers 312 include a web server 322, an API server 324, and a messaging server 326 to provide interfaces to one or more application servers 330. Application servers 330 of network-based system 310 may be structured, arranged, and/or configured to provide various online marketplace and/or ticket fulfillment services to users that access network-based system 310.

In various usage scenarios, client 302 may communicate with applications servers 330 of network-based system 310 via one or more of a web interface provided by web server 322, a programmatic interface provided by API server 324, and a messaging interface provided by messaging server 326. It can be appreciated that web server 322, API server 324, and messaging server 326 may be structured, arranged, and/or configured to communicate with various types of client devices 304 and/or client programs 306 and may interoperate with each other in some implementations.

Web server 322 may be arranged to host web pages (e.g., HTML documents) and provide an appropriate web interface (e.g., HTTP, CGI, etc.) for enabling data to be presented to and received from entities via the Internet. Web server 322 may be arranged to communicate with web clients and/or applications such as a web browser, web browser toolbar, desktop widget, mobile widget, web-based application, web-based interpreter, virtual machine, and so forth. Web server 322 may provide a web interface to enable access by client 302 and/or third party 312 to the various services and functions provided by application servers 330. For example, web server 322 may be arranged to receive data from client 302 and/or third party 312 and to pass the data to one or more application servers 330 within network-based system 310. Web sever 322 also may present client 302 and/or third party 312 with relevant static and dynamic content hosted by network-based system 310 in response to various requests and/or events.

API server 324 may be arranged to communicate with various client programs 306 and/or a third-party application 316 (e.g., third-party web site) comprising an implementation of API for network-based system 310. API server 324 may provide a programmatic interface to enable access by client 302 and/or third party 312 to the various services and functions provided by application servers 330. For example, the programmatic interface provided by API server 324 may be used for batch-mode and/or real-time communication with a high-volume seller for receiving and updating inventory listings. The programmatic interface provided by API server 324 also may be used to communicate relevant static or dynamic content hosted by network-based system 310 to an API implementation of one or more client programs 306 and/or a third-party application 316 (e.g., third-party web site). The API implementation may comprise, for example, executable code in accordance with a SDK provided by network-based system 310.

Messaging server 326 may be arranged to communicate with various messaging clients and/or applications such as e-mail, IM, SMS, MMS, telephone, VoIP, video messaging, and so forth. Messaging server 326 may provide a messaging interface to enable access by client 302 and/or third party 312 to the various services and functions provided by application servers 330. For example, the messaging interface provided by messaging server 326 may be used to communicate with client 302 and/or third party 312 in a variety of ways such as via e-mail, IM, SMS, MMS, video messaging, and/or a telephone call (e.g., landline, mobile, VoIP) with a customer service agent and/or IVR system.

When implemented as an online ticket marketplace, application servers 330 of network-based system 310 may provide various online marketplace and ticket fulfillment services including, for example, account services, buying services, selling services, listing catalog services, dynamic content management services, delivery services, payment services, and notification services. In the exemplary embodiment shown in FIG. 4, application servers 330 may comprise an account server 332, a buying server 334, a selling server 336, a listing catalog server 338, a dynamic content management server 340, a payment server 342, a notification server 344, and a delivery server 346 structured and arranged to provide such online marketplace and ticket fulfillment services.

Application servers 330, in turn, may be coupled to and capable of accessing one or more databases 350 including a subscriber database 352, an active events database 354, and a transaction database 356. Databases 350 generally may store and maintain various types of information for use by application servers 330 and may comprise or be implemented by various types of computer storage devices (e.g., servers, memory) and/or database structures (e.g., relational, object-oriented, hierarchical, dimensional, network) in accordance with the described embodiments.

Account server 332 implemented by one or more of application servers 330 may allow a user to establish and/or manage a subscriber account with network-based system 310. For example, while some services provided by network-based system 310 may be generally accessible, a user may be required to access an existing subscriber account or register a new subscriber account with network-based system 310 in order to receive certain customized and/or subscriber-specific services.

To create a subscriber account, a user may provide network-based system 310 with account information such as a unique username, e-mail address, password, name, location (e.g., address, city, country, and/or zip code), telephone numbers (e.g., home, work, and/or mobile), and/or other required information for identifying and/or authenticating the user. After receiving the required account information and instructions from the user to create the subscriber account, network-based system 310 may create the subscriber account and store the account information in subscriber database 352.

After a subscriber account is created, the user may view and/or make changes to account information, add or edit existing contacts, retrieve or change the password, view and edit sources of funds and/or financial value on file, view and edit payment options, and/or otherwise manage the subscriber account.

To effectuate the buying or selling of goods such as event tickets, the user may be required to link the subscriber account of to a source of funds and/or financial value for completing different transactions via network-based system 310. It can be appreciated that the user may provide various types of entities or third-party financial accounts capable of supplying or receiving funds and/or financial value in accordance with the described embodiments. Exemplary entities and/or third-party financial accounts may include, without limitation, a bank, bank account, lender, line-of-credit, credit card company, credit card account, debit card, prepaid debit card account, third-party payment services account (e.g., PayPal™ account), payroll account, check, money order, or any other suitable source of financial value.

Additionally or alternatively to linking the subscriber account to a source of financial value based on a commercial currency (e.g., U.S. dollar), a user may link to the subscriber account to a source of financial value based on a proprietary and/or promotional currency (e.g., points, rewards, coupons) capable of accumulation and/or redemption by the user to pay for goods or services. It can be appreciated that multiple sources of funds and/or financial value associated with the user may be linked to the subscriber account enabling the user to select among such sources to effectuate different payment transactions via network-based system 310.

The user may select various options for receiving payment when a sale is effectuated via network-based system 310. For example, the user may request payment for sales via check, deposit to a third-party payment services account (e.g., PayPal™ account) or Season Ticket Account, and/or other type of source capable of receiving funds and/or financial value in accordance with the described embodiments. In some implementations, the user may select to donate some or all of the proceeds of a sale to a third-party such as a non-profit organization or entity (e.g., charity, foundation, fund, alliance, society) as described in co-pending U.S. patent application Ser. No. 10/697,850 titled “System and Method for Providing Logistics for a Sale or Transfer of Goods with Proceeds Provided to a Third Party,” which was filed on Oct. 30, 2003 and is incorporated by reference in its entirety.

When accessing the subscriber account, the user may view and/or manage various details of past and pending transactions. For example, the subscriber account may provide a seller with details regarding past and pending ticket sale listings (e.g., shipped, canceled, inactive, expired, deleted, active, pending confirmation, awaiting shipment) and may allow the user to track event listings, modify the prices of event listings, view and confirm received orders, view and confirm orders to ship, print or reprint shipping labels, view shipped orders, view canceled orders, view the status of payments and edit payment options, view past payments, and so forth. The subscriber account also may provide a buyer with details regarding past and pending ticket purchase transactions (e.g., past orders, purchased, delivered, canceled, expired, order status, delivery status, active bids, auctions lost) and may allow the user to view order history, track active bids, modify offers, download and print electronic tickets, view and edit payment options, and so forth.

In various implementations, the user may customize a subscriber account with one or more interests and ticketing preferences. For example, the user may add and edit information associated with the subscriber account regarding one or more cities, venues, artists, teams and sporting events, theaters, and season ticket and packages of interest to the user.

The user also may customize a subscriber account with one or more notification preferences. For example, the user may configure the subscriber account to receive notifications, change notifications, and/or discontinue notifications. In some cases, the user may request to receive promotions via an e-mail newsletter featuring events happening in a particular location. The user also may subscribe to receive customized alert notifications in a variety of ways such as via e-mail, IM, SMS, MMS, and/or other suitable delivery mechanism. In addition to receiving such notifications via e-mail, IM, SMS, MMS, the user may access the subscriber account and view recent notifications such as alert notifications and other messages received in the past week.

Selling server 334 implemented by one or more of application servers 330 may allow a user to offer goods for sale via an online marketplace provided by network-based system 310. To list goods for sale such as a single or multiple event tickets, a seller may provide network-based system 310 with required event information such as event, location of the tickets, sale type, ticket quantity, seating details (e.g., section, row, seat, comments), price, and payment method. After receiving the required event information and instructions from the seller to publish an event listing, network-based system 310 may create an active event and store the event information in active events database 354 for publication to users of network-based system 310. It can be appreciated that upon the sale of the tickets, one or more delivery options may be available depending on the locations of the buyer and the seller, the time remaining before the event, and/or the form of the tickets (e.g., physical tickets, electronic tickets).

In various embodiments, a seller may post an event for publication as described in co-pending U.S. patent application Ser. No. 11/689,787 titled “System and Method for Posting Multiple Items for Sale,” which was filed on Mar. 22, 2007 and is incorporated by reference in its entirety. In such embodiments, the seller may select the appropriate type of event, city, or venue for event tickets being offered for sale, and then may be queried or prompted to select a specific event after making selections from various categories and subcategories presented via a set of interactive pull-down menus.

In one implementation, for example, a seller may be presented with a pull-down menu listing categories such as sports tickets, concert tickets, theater and arts tickets, and ticket gift certificates. If the seller selects the sports tickets category, a pull-down menu listing sports tickets such as baseball tickets, basketball tickets, football tickets, and other types of sports tickets is presented. If the seller then selects football tickets, a pull-down menu listing sports subcategories such as NFL tickets, CFL tickets, and NCAA tickets is presented. If the seller selects the NFL tickets, a pull-down menu listing ticket subcategories such as NFL regular season tickets, NFL playoff tickets, and NFL pro bowl tickets is presented. If the seller selects the NFL regular season tickets, a pull-down menu listing NFL teams is presented. Once the seller selects tickets for particular NFL team, a listing of available events including event details (e.g., team and opponent, date, time, venue name) for the team are displayed which can be sorted by event, date, and venue. The seller may then select an event from the listing of available events. It can be appreciated that appropriate sets of pull-down menus for listing categories and successive subcategories may be presented for any type of event ticket in accordance with the described embodiments.

After an event has been selected, the seller may provide network-based system 310 with the shipping location of the tickets and verify current contact information (e.g., address and telephone phone number). The seller may provide a sale type such as a fixed price sale (e.g., set price capable of subsequent modification), a declining price sale (e.g., automatically decreasing price over time from maximum price to minimum), or an auction sale (e.g., buyers bid from a starting price during an open period with the highest bidder placing an order when the auction closes).

The seller may provide the ticket quantity for specific seats or general admission. The seller may provide the ticket quantity and may allow the quantity of offered tickets to be split among several buyers in multiples of two. The seller may provide seating and ticket details for the offered tickets such as section, row, seat numbers, and may provide other comments. In some cases, the seller may select to prevent buyers from viewing the specific seat numbers when the event listing is published by network-based system 310.

The seller may provide the price per ticket and the ending date of the sale when the event listing is to be removed from publication. For some events, the event listing may expire three business days before the event. In certain markets, tickets may be sold on consignment and the listing may remain until the start of the event.

The seller may provide a selected payment method for the sale of the tickets such as via check, deposit to a third-party payment services account (e.g., PayPal™ account), Season Ticket Account, and/or other type of source capable of receiving funds and/or financial value, and/or donation to a third-party such as a non-profit organization or entity.

Buying server 336 implemented by one or more of application servers 330 may allow a user to locate goods offered for sale via an online marketplace provided by network-based system 310. To find goods for sale such as a single or multiple event tickets, a buyer may view active event listing published by network-based system 310.

In accordance with various embodiments, information may be presented to and/or received from information from the user via one or more user interfaces presented on the display of a client device (e.g., PC or mobile device). The user interfaces presented to the user by a client-side web application may comprise a search engine interface (e.g., text entry boxes, input fields, checkboxes, clickable hyperlinks, pull-down menus, etc.) for allowing the user to provide event criteria for searching and/or filtering event listings. The user interfaces presented to the user also may comprise search results including upcoming event listings that satisfy the event criteria.

For example, the buyer may browse active event listings by clicking and following links for various event categories and subcategories such as sports tickets, concert tickets, theater tickets, cities, sports, teams, artists, show type (e.g., Broadway, opera, ballet, comedy), event names, and so forth. The buyer also may search for events using a search engine interface and/or one or more pull-down menus. For example, the buyer may enter one or more keywords into a search engine text entry box and view results comprising active events that satisfy the query. In various implementations, the buyer may be presented with a ticket finder screen comprising a plurality of pull-down menus for allowing the buyer to quickly formulate a search by selecting a category (e.g., sports, concert, theater, etc.), a location (e.g., city), and a number of tickets from the pull-down menus.

In some embodiments, a user may search for and/or request upcoming event information based on a variety of event criteria such as an event name, category, city, venue, artist, genre, team, player (e.g., starting pitcher, favorite player), theater, date range, date, number of tickets, price range, ticket attributes (e.g., zone range, zone, section range, section, row range, row, seat number range, seat number), and/or combination thereof. Accordingly, the event criteria included in a search query may comprise ticket attributes as well as one or more conditions associated with the event parameters for requesting information for such upcoming events only when such conditions are met.

It can be appreciated that various combinations of event criteria are possible in accordance with the described embodiments. For example, a user may request upcoming event information specifying combinations such as a certain number of tickets and a maximum price, a particular artist and a certain city, a certain player and a particular event venue, and so forth. A user also may request upcoming event information based on one or more ticket attributes. For instance, a user may request a certain number of tickets for an upcoming event in one or more specified zones, sections, rows, and/or or seats. Additionally, event criteria may be applied alone or in combination across one or more events. A user may request, for example, tickets in a certain row (e.g., front row) or row range (e.g., rows 1-5) within a specified zone (e.g., club infield) or section (e.g., section 224) for a designated team (e.g., professional baseball team) and/or for one or more games (e.g., particular opponent, rivalry game). The embodiments are not limited in the regard.

It can be appreciated that in some cases, an upcoming event may not satisfy all event criteria specified by the user. For example, tickets for an upcoming event may be available but not within a price range specified by the user. Additionally, there may be no upcoming events that satisfy the event criteria specified by the user when there are no available tickets such as when no sellers have listed tickets for an event and/or before tickets for an event go on sale. In such cases, the client-side web application may inform the user that there are no search results satisfying the search criteria and then perform a new search with relaxed search criteria. Alternatively or additionally, the client-side web application may automatically relax the search criteria and attempt another search.

Once a buyer has located and selected an event, the tickets being offered for sale for the event may be presented to the buyer. In various embodiments, the user may view the details of tickets being offered for sale and the location of tickets in the event venue as described in co-pending U.S. patent application Ser. No. 11/552,782 titled “Method and System for Illustrating Where a Ticket is Located in an Event Venue,” which was filed on Oct. 25, 2006 and is incorporated by reference in its entirety. In such embodiments, the buyer may be presented with an interactive event venue seat map and details of available tickets according to criteria specified by the buyer.

In one implementation, for example, after selecting an event the buyer may be presented with an interactive event venue seat map and an initial listing of all event tickets for sale. The event listings may include details such as section, row, quantity, and price and may be sorted by the buyer according to such details. The sections of the interactive event venue seat map for which tickets are available may be displayed in color while sections having no available tickets may be displayed in white.

Within the interactive event venue seat map, comparable or similarly-located (e.g., upper level) sections having available tickets may be displayed in the same color while sections having available tickets that are not comparable or similarly-located may be displayed in different colors. For example, the colors used in the sections may correspond to zones for the sections with each zone comprising several comparable or similarly-located sections. Along with the interactive event venue seat map, the buyer may be presented list comprising the different zone names and the color used for each zone. The names of zones having available tickets may be displayed in black text, while the names of zones having no available tickets may be displayed in gray text.

When presented with the interactive event venue seat map, the buyer may roll over a particular section causing a roll-over screen to appear indicating the quantity and price range of tickets available in that section. By clicking on a particular section, the event listings may be filtered to display only the event listings in the selected section along with the specific details (e.g., section, row, quantity, price) for such tickets. The buyer also may zoom-in, zoom-out, drag, and/or rotate the interactive event venue seat map.

When presented with the initial listing of all event tickets for sale, the buyer may filter the initial listing by inputting criteria such as one or more price ranges (e.g., $75-$286, $286-$349, $349-$442, $442-$559, and $559 and up). Once the buyer selects a price range, the event listings are filtered to display only the event listings in the selected price range. Additionally, the interactive event venue seat map is modified to display sections in color for which tickets are available in the selected price range.

Each event listing may include ticket attributes such as section, row, quantity, and price. Each listing also may include a link to view additional details that when clicked may display the ticket attributes along with further ticket details (e.g., seat numbers, time remaining to purchase the tickets, seller comments, delivery options), a selectively enlargeable image of the event venue for reviewing the location of the seats, and an action button for initiating purchase of the tickets.

To place an order for the tickets, the buyer may provide a delivery location, select a method of payment (e.g., credit card), confirm the transaction details (e.g., description of the tickets, delivery method, delivery location, payment amount, and method of payment), and the complete the purchase. When the buyer places the order, a confirmation e-mail is sent to the buyer, and the seller is notified of the order request via e-mail and requested to confirm the availability and delivery of the tickets. Upon receiving confirmation from the seller that the tickets have been sent, the buyer is notified as to when delivery can be expected. It can be appreciated that upon the sale of the tickets, one or more delivery options may be available depending on the locations of the buyer and the seller, the time remaining before the event, and/or the form of the tickets (e.g., physical tickets, electronic tickets).

Listing catalog server 338 implemented by one or more of application servers 330 may be arranged to receive and respond to queries and/or to provide access to event information stored in active events database 354. A query to listing catalog server 338 may comprise, for example, a search query, web query, web feed request (e.g., RSS feed request, ATOM feed request), API request, HTTP request (e.g., Get, Post, etc.), a web form submission (e.g., XHTML/HTML form), and/or suitable request mechanism in accordance with the described embodiments. In various implementations, a query may be submitted to listing catalog server 338 via one or more communications servers 320 from one or more client devices 304, client programs 306, a third-party server 314, and/or a third-party application 316. Queries also may be submitted to listing catalog server 338 internally from other application severs 330 of network-based system 310.

In one embodiment, listing catalog server 338 may be implemented by a distributed architecture comprising a plurality of distributed indexing modules. Each of the distributed indexing modules may provide an interface for receiving queries from front-end servers such as communications servers 320. The distributed indexing modules may store and build updatable indexes against which a query can be checked to expedite retrieval of a query result. The indexes may comprise, for example, common keywords or search terms and event IDs linked to such keywords or search terms. The distributed indexing modules also may cache common query results.

The distributed indexing modules may be arranged to receive updated indexing information brokered via a message bus from a local gatherer module. The local gatherer, in turn, may be coupled to and collect indexing information from active events database 354. The indexing modules may update and/or filter the indexes based on the updated information received from the local gatherer module and/or information from other indexing modules.

The local gatherer module may be arranged to periodically scan items stored in active events database 354 and obtain updated indexing information. For example, the local gatherer module may request items from active events database 354 that have changed within a given time period. The event information stored in active events database 354 may change frequently as new event listings for upcoming events are added and then removed when the tickets for such events listings are purchased. Furthermore, active events database 354 may store relatively static information for an event such as category (e.g., sports, concerts, theater), as well as real-time dynamic information such as current event listings and true levels of ticket inventory. It can be appreciated that the event information maintained by active events database 354 may be extremely dynamic especially in cases where LMS and electronic ticketing services are provided by network-based system 310.

Listing catalog server 338 may receive and respond to the queries with event information for upcoming events that satisfy such queries. The event information may be provided locally from listing catalog server 338, if available (e.g., cached), and/or may be retrieved by listing catalog server 338 from active events database 354. In various implementations, event information from listing catalog server 338 may be communicated via one or more communications servers 320 to one or more client devices 304, client programs 306, a third-party server 314, and/or a third-party application 316. The event information from listing catalog server 338 also may be provided internally to other application severs 330 of network-based system 310.

Exemplary event information parameters that may be included in the response from listing catalog server 338 are described below in the following table.

EVENT INFORMATION PARAMETER TABLE

| Event Parameter | Details |
|---|---|
| act_primary | Home Team Mascot |
| act_secondary | Away Team Mascot |
| active_type | 1 = active event |
| | 0 = inactive event |
| allowedtosell | 1 = general public allowed to sell tickets |
| | 0 = generatl public not allowed to sell tickets |
| ancestorGenreIds | List of parent IDs, in order of hierarchy, |
| | identifying browsing path to reach the node |
| ancestorGeoIds | List of geography IDs, in order of hierarchy, |
| | identifying browsing path to reach the |
| | geography node |
| canceled | 1 = event has been canceled |
| | 0 = event has not been canceled |
| channel | Name of the top level genre in the |
| | breadcrumb trail tied to the event |
| channelId | ID of the top level genre in the |
| | breadcrumb trail tied to the event |
| channelUrlPath | URL path for the top level genre in the |
| | breadcrumb trail tied to the event |
| channel_facet_str | ID and Name of the top level genre in the |
| | breadcrumb trail tied to the event |
| city | City of the event |
| date_last_modified | Time of last change to the event |
| description | Name of the event |
| eventDate_facet_str | Month and year of the event, numeric |
| | (yyyy-mm) and alpha (month, yyyy) |
| eventGeoDescription | Name of venue |
| event_date | Date and time of the event (GMT) |
| event_date_local | yyyy-mm-dd of the event |
| event_date_time | Date and local time of the event |
| event_id | Unique ID of the event |
| event_time_local | Local time of the event |
| genreUrlPath | URL path for the parent genre of the event |
| genre_parent | ID of the parent genre of the event |
| geoUrlPath | URL path for the venue of the event |
| geography_parent | ID of the parent geo of the venue |
| hide_event_date | 1 = event date hidden |
| | 0 = event date not hidden |
| id | ID of the event |
| last_chance | Date and time to delist the event used in place |
| | of the actual event date due to shipping rules |
| maxPrice | Highest ticket price for the event |
| maxSeatsTogether | Maximum number of successive seats that |
| | can be purchased together |
| minPrice | Lowest ticket price for the event |
| name_primary | Event match-up using team mascots (e.g., |
| | Mets vs Braves) |
| name_secondary | Full name of the away team (e.g., New York |
| | Mets) |
| spark_event_flag | Event marked as a “hot” event |
| state | State of the event |
| totalPostings | Number of actual postings for the event |
| totalTickets | Actual number of tickets listed for the event |
| venue_config_id | Configuration of the venue for the event |

It can be appreciated that, in some implementations, not all of the event information parameters included in the table may be necessary to present the requested upcoming event information to the user. Accordingly, when all of the event information parameters are included, the response may be parsed to extract only those event information parameters that are needed. Alternatively, the query and/or the response may be configured to request and respond with only those event information parameters necessary to display the requested upcoming event information. It also can be appreciated that the response may include different event information parameters and/or additional event information parameters than those described in the table.

Dynamic content management server 340 implemented by one or more of application servers 330 may be arranged to provide a user with relevant and/or related dynamic content customized according to a particular context of the user. The dynamic event information may comprise, for example, event information that changes as new event listings for upcoming events are added and as event listings are removed when the tickets for such events listings are purchased and real-time event-specific information such as current event listings, price ranges, and true levels of ticket inventory. Relevant or related dynamic content may comprise, for example, dynamic content customized according to the location of the user such as location-based advertising content (e.g., banner ads), relevant and/or related categories and subcategories (e.g., links for local sports teams, artists performing in the location, theater shows playing in the location), a list of event names and dates for upcoming events in the location arranged by category, and/or other type of dynamic featured content that changes according to the location of the user.

In some implementations, the appearance of a user interface displayed to the user may be customized or branded with dynamic content based on the location of the user and/or event criteria specified by the user. For example, a web page or web client may comprise a comprise a header, skin, or other designated area that dynamically displays different graphics (e.g., pictures, logos, backgrounds, etc.), advertisements, news, and/or other featured content received from the network-based system 310 according to the location and/or event criteria of the user.

In various embodiments, the dynamic content management server 340 may be structured, arranged, and/or configured to bind dynamic information to a particular node and/or combination of nodes defining the context of the user. Exemplary nodes may include, for example, geography nodes (e.g., event cities), category nodes (e.g., sports, concerts, theater), sports nodes (e.g., baseball, football, basketball), sports subcategory nodes (e.g., professional, college), music genre nodes (e.g., jazz, rock, alternative), theater subcategory nodes (e.g., musical, comedy), ticket subcategory nodes (e.g., regular season, playoff, bowl), conference nodes, team nodes, artist nodes, theater show nodes, venue nodes, event nodes, and so forth. It can be appreciated such nodes may be arranged (e.g., hierarchically) and/or in other ways in accordance with the described embodiments.

Dynamic content management server 340 may be configured bind dynamic content such as relevant and/or related categories and subcategories, event listings for upcoming events, promotional or advertising content, UI graphics, and/or various other types of customized content to a node or combination of nodes. When navigating a web site provided by network-based system 310, for example, the user may be presented with links for selecting from among various locations, categories, and/or subcategories and for viewing content associated with such selections. When the user makes a particular selection, the context of the user may be defined by one or more nodes associated with such selection, and the user may be presented with dynamic content customized to the context of the user.

In various embodiments, dynamic content management server 340 may implement a front-end query tool and presentation layer to query listing catalog server 338 according to the context of the user. In response to the query, dynamic content management server 340 may receive dynamic content (e.g., XML content) from listing catalog server 338 and provide the dynamic content to one or more dynamic content modules embedded in a web page presented to the user. Accordingly, the content associated with event listings may change based on the context of the user, configurable parameters, and/or available inventory.

In one example, a user selects a particular city, and dynamic content management server 340 has bound dynamic content to a geography node associated with the particular city. Upon selection of the particular city by the user, the context of the user may be defined at least in part by the geography node of the selected city, and the user may be presented with the dynamic content that is bound to the geography node. In this case, the user may be presented with a web page including dynamic content customized for the particular city such as graphics (e.g., pictures, background) and advertising content (e.g., banner ads) for the particular city, relevant and/or related categories and subcategories (e.g., links for local sports teams, artists performing in concert in the city, theater shows playing in the city), a list of event names and dates for upcoming events in the city arranged by category, and/or other type of dynamic content that changes according to the city selected by the user.

In another example, a user selects a particular football team, and dynamic content management server 340 has bound dynamic content to a team node associated with the particular football team. Upon selection of the team by the user, the context of the user may be defined at least in part by the team node, and the user may be presented with the dynamic content that is bound to the team node. In this case, the user may be presented with a web page including dynamic content customized for the particular team. For example, the web page presented to the user may be dynamically branded with graphics (e.g., pictures, background), advertising content (e.g., banner ads), and/or news associated with the particular team. The user also may be presented with event listings for upcoming games for the team as well as relevant and/or related categories and subcategories (e.g., links for road games, playoff games) for the team. In this implementation, the context of the user may be defined by one or more other nodes in a hierarchical path to the team node such as a category node (e.g., sports), sports nodes (e.g., football), sports subcategory node (e.g., professional), and ticket subcategory node (e.g., regular season). As such, the user may be presented with dynamic content bound to one or more of such nodes such as links to other professional football teams for which regular season tickets are available.

It can be appreciated that the embodiments are not limited to the foregoing examples and that dynamic content may be bound to a particular nodes and/or a combination of nodes for customizing that content displayed to a user based on the context of the user. Accordingly, dynamic content management server 340 may be used to create dynamic content campaigns including a various types of static and dynamic content and to bind such campaigns to nodes or groups of nodes that define a context of the user. It also can be appreciated that a node and/or combination of nodes can be detected as a user selects one more links and/or in other ways such as when a query is submitted (e.g., text entry, selection of checkboxes, selection from a pull-down menu), a search result is returned, or in any other way in accordance with the described embodiments.

Payment server 342 implemented by one or more of application servers 330 may be arranged to effectuate and/or manage payments between buyers and sellers and to post and track financial transactions for users of network-based system 310. Transaction information for past and pending transactions may be stored by network-based system 310 in transaction database 356. Payment server 342 also may provide dispute resolution mechanisms to handle payment disputes arising between transacting parties and/or fraud prevention mechanisms to prevent fraudulent transaction, unauthorized use of financial instruments, non-delivery of goods, abuse of personal information, and so forth. While payment server 342 is shown in FIG. 4 as forming part of networked-based system 310, it will be appreciated that payment server 342 may form part of a third-party payment system that is separate and distinct from network-based system 310 in alternative embodiments.

In various implementations, payment server 342 may account for a transfer of funds and/or financial value by debiting the a source of funds and/or financial value linked to the subscriber account of the buyer and crediting a source of funds and/or financial value linked to the subscriber account of the seller. For example, the network-based system may securely communicate with one or more financial institutions such as a bank or credit card company over one or more networks 308 and arrange the transfer of funds and/or financial value from the buyer to the seller. It can be appreciated that while certain settlement mechanisms may be described for purposes of illustration, the embodiments are not limited in this regard, and a variety of settlement networks and modalities may be used in accordance with the described embodiments.

In one embodiment, after the buyer reviews and confirms an order, the account (e.g., credit card) of the buyer is verified, and the sale amount (e.g., ticket price plus delivery cost) is authorized. The seller is notified of the proposed purchase by e-mail or other notification mechanism and requested to confirm that the tickets are still available and that the transaction can be completed.

Upon receiving confirmation from the seller, the account (e.g., credit card) of the buyer is charged. Funds from the account of the buyer may be electronically transferred into a merchant account associated with network-based system 310, and a transaction fee may be deducted. The remaining proceeds are then directed to the seller by issuing a payment in accordance with the payment method selected by the seller such as via check, deposit to a third-party payment services account (e.g., PayPal™ account), Season Ticket Account, and/or other type of source capable of receiving funds and/or financial value, and/or donation to a third-party such as a non-profit organization or entity.

It can be appreciated that network-based system 310 may provide a “double blind” complete ticket-sale transaction without interaction between buyer and seller. Namely, network-based system 310 may facilitate an entire ticket-sale transaction without requiring any interaction between the seller and the buyer. Network-based system 310 controls and/or facilitates the entire sale and purchase process and serves as an intermediary between the buyer and seller effectively isolating the participation of the seller in the transaction from the participation of the buyer in the transaction. Accordingly, the identity of one transacting party can remain concealed from the other.

Notification server 344 implemented by one or more of application servers 330 may be arranged to generate and send various types of notifications to users of network-based system 310. The notification server 344 may communicate with users over one or more types of networks 308 (e.g., the Internet, a WAN, a WWAN, a WLAN, a mobile telephone network, a landline telephone network, a VoIP network, etc.) via interfaces provided communications servers 320 such as web server 322, API server 324, and/or messaging server 326. It can be appreciated that, in some implementations, notifications may be forwarded to users via an intermediary such as an Internet Service Provider (ISP), online service provider (OSP), web-based e-mail service provide, message aggregator (e.g., SMS aggregator), mobile transaction network entity, and so forth.

The notifications may comprise messages delivered to users via e-mail, IM, SMS, MMS, video message, telephone call as well as messages delivered to the subscriber account of the user. In some cases, the notifications may provide the user with information related to various online marketplace transactions. For example, notifications may be sent to sellers for indicating the status of event listings, informing the seller of offers (e.g., auction bids) for event listings or sales of similar tickets and allowing the user to modify the prices of event listings, notifying the seller of placed orders and requesting confirmation of the availability of tickets for such orders, providing delivery instructions and requesting confirmation of delivery, tracking shipped orders, providing the status of payments, and so forth. Notifications may be sent to buyers for tracking ticket purchase transactions (e.g., active bids, auctions lost) for event listings and allowing the buyer to modify offers, confirming an order and delivery, tracking shipped orders, providing pick-up instructions and requesting confirmation of receipt, downloading and print electronic tickets, and so forth.

In various embodiments, the user may subscribe to receive customized alert notifications for upcoming events as described in co-pending U.S. patent application Ser. No. 12/262,468 titled “System and Methods for Upcoming Event Notification and Mobile Purchasing,” which was filed on Oct. 31, 2008 and is incorporated by reference in its entirety. In such embodiments, notification server 344 may be arranged to generate and send an alert notification comprising a text message including relevant static or dynamic event information as well as an embedded hyperlink. The hyperlink may comprise a hyperlinked telephone number for allowing the user to place a telephone call to an agent of network-based system 310 for transacting a mobile purchase. Alternatively or additionally, the hyperlink may comprise a URL or URI for navigating to network-based system 310 for transacting the mobile purchase.

It can be appreciated that in some cases, an upcoming event may not satisfy all event criteria specified by the user. In some implementations, when there are no upcoming events that satisfy all the event criteria specified by the user, the user may select to receive alert notifications for one or more upcoming events conditioned on the complete satisfaction of the event criteria. In such implementations, network-based system 310 may allow the user to select to receive an alert notification whenever an upcoming event that substantially and/or completely satisfies the search criteria is listed. For example, the user may select to receive “on sale” alert notifications when tickets that satisfy one or more preferences of the user become available. The network-based system 310 also may provide the user with various capabilities (e.g., preference settings and options) to allow the user to receive “on sale” alert notifications for preferred tickets and to allow the user to automatically and/or optionally purchase such preferred tickets.

Delivery server 346 implemented by one or more of application servers 330 may arrange the delivery of goods from the seller to the buyer. For the delivery of time-sensitive goods such as a single or multiple event tickets, network-based system 310 may determine and present delivery options that ensure that an event ticket is delivered to the buyer before an event and the costs associated with such delivery options.

In various embodiments, network-based system 310 may coordinate the delivery of event tickets as described in co-pending U.S. patent application Ser. No. 09/867,171 titled “System and Method for Providing Logistics for a Sale of Goods,” which was filed on Sep. 27, 2001 and is incorporated by reference in its entirety. In such embodiments, network-based system 310 may automatically arrange and/or facilitate the logistics for the delivery of event tickets from the seller to the buyer.

In one implementation, for example, when the buyer places an order, available delivery options are presented to the buyer that ensure that the event tickets can be delivered before the event either to the buyer or to a pick-up location (e.g., event venue will call or an office of network-based system 310) in proximity to the buyer. Network-based system 310 may determine all available delivery options based on the form of the tickets (e.g., physical tickets, electronic tickets), the time remaining before the event, the location of the goods, the location of the buyer, pick-up locations in proximity to the buyer, and/or the capabilities one or more couriers (e.g., air/land couriers, express couriers, local couriers or “runners”) that can execute the delivery within the time remaining before the event.

When a physical ticket is to be delivered, network-based system 310 may determine and present shipping options to the buyer. The buyer may provide a delivery or pick-up location, and network-based system 310 may automatically determine couriers capable of ensuring delivery and present a list identifying the couriers, the available shipping methods (e.g., two day, one day, overnight, same day) for each courier, and the associated cost of each shipping method.

When a courier and shipping method is selected by the buyer, the seller may be notified and presented with a printable shipping label for the courier and logistics for providing the tickets to the courier. For example, network-based system 310 may automatically determine the closest courier facility in proximity to the seller and may allow and arrange for the courier to retrieve the tickets. In such cases, network-based system 310 may communicate relevant information (e.g., seller address, delivery address, pick-up day and time frame) to the courier in order to coordinate ticket retrieval. If the courier cannot service any of the selected locations at any of the selected times, network-based system 310 may require the seller to drop off the tickets at the nearest courier facility. The seller also may select to drop off the tickets at the nearest courier facility. If the seller selects or is required to drop off the tickets, the buyer may be provided with the location of the courier facility, driving or walking directions to the courier facility, and/or a map showing the courier facility.

Upon confirmation by the seller that the tickets have been sent or picked up, network-based system 310 may communicate delivery tracking information to the buyer and/or seller. Network-based system 310 may notify the buyer of the delivery location and expected time and date of delivery. If the delivery location is at a pick-up location such as the event venue will call or an office associated with network-based system 310, the buyer may be provided with the pick-up location, driving or walking directions to the pick-up location, and/or a map showing the pick-up location.

To ensure delivery to the buyer before an event, a last sale time may be associated with an event listing. In some cases, for example, the last sale time for an event listing may be three business days before the event to provide sufficient transit time to ensure completion of delivery. In such cases, the event listing will expire at the last sale time.

It can be appreciated that both sellers and buyers may desire the last sale time to be as close to the event start time as possible in order to maximize the opportunity to make a sale and the opportunity to witness an event. Accordingly, network-based system 310 may provide sellers and buyers with various last minute services (LMS) for maintaining an event listing and the ability to sell and purchase listed tickets right up to the start of the event.

In one implementation, for example, network-based system 310 may allow tickets to be sold on consignment and may maintain an event listing until the start of the event. When a seller requires delivery of physical tickets for an upcoming event, the seller may select to sell the tickets using LMS provided by network-based system 310. The seller may request LMS and provide network-based system 310 with contact information (e.g., name, address, telephone number, e-mail address), ticket information (e.g., event name, event venue, ticket event dates, closest city to the event), and authorization to release the tickets.

In response to the LMS request, the seller may be contacted by an agent of network-based system 310 via telephone or other contact method and provided with additional selling information. Depending on the time remaining before the event, the seller may be instructed to ship or physically deliver the tickets to an LMS center associated with network-based system 310. Typically, the location of the LMS center will be in close proximity to the event venue. The seller also may select to physically deliver the tickets to the LMS center. When physical delivery of the ticket to the LMS center is required or selected, the seller may be provided with the location of the LMS center, driving or walking directions to the LMS center, and/or a map showing the LMS center.

Once the tickets are delivered to the LMS center, the event listing may be maintained until the start of the event and the subsequent delivery of the tickets to a buyer is handled by network-based system 310. For example, the LMS center and/or network-based system 310 may handle the responsibility of shipping the tickets to the buyer, delivering the tickets to the event venue will call, and/or the keeping the tickets at the LMS center until pick-up by the buyer. It can be appreciated that the LMS provided by network-based system 310 may facilitate delivery and allow network-based system 310 to defer the last sale time until the start of the event.

In various embodiments, network-based system 310 may provide electronic ticketing services for allowing a buyer to purchase one or more electronic tickets that can be used at the event venue. It can be appreciated that providing such electronic ticketing services may allow network-based system 310 to defer the last sale time until the start of the event.

When the user selects an upcoming event from event listings published by network-based system 310, a web page may be presented to the user that includes event information for the selected upcoming event such as the name of the event, the date and time of the event, the event venue, available ticket listings including ticket attributes (e.g., section, row, quantity, price), and so forth. In some cases, a purchaser of event tickets may provide the event information to network-based system 310 in order to list the tickets for sale on a secondary market. In other cases, the venue, event promoter, or other type of ticket issuer may provide network-based system 310 with event details such as event description, event venue, event date and time, artist, and so forth. In response, network-based system 310 may manage the event, enable the venue to sell tickets for the event, manage the generation and distribution of electronic tickets, and facilitate the use of electronic tickets for access control to the venue. For example, network-based system 310 may create an event listing, generate electronic tickets, publish available tickets for sale, and coordinate the sale of the electronic tickets.

In various embodiments, a web page presented to a user may comprise the event information along with a link to purchase electronic tickets and/or a link to view additional details. By clicking the link to purchase electronic tickets, the user may initiate a purchase of one or more electronic tickets. By clicking the link to view additional details, a subsequent web page may be displayed including ticket attributes along with further ticket details (e.g., seat numbers, time remaining to purchase the tickets, seller comments, delivery options), a selectively enlargeable image of the event venue for reviewing the location of the seats, and an action button for initiating purchase of the tickets. In some cases, one or more web pages may include a link to view delivery options such as a location of, driving or walking directions to, and/or a map showing a pick-up location.

To effectuate an electronic ticket purchase, the user may be prompted to enter account information such as a unique username or e-mail address and a password. Upon receiving the required account information, the user is authenticated with network-based system 310 and may initiate an electronic ticket purchase. After authentication, network-based system 310 may transact the purchase using a source of financial value linked to the subscriber account of the user or may request the user to supply payment information (e.g., credit card account, PayPal™ account, etc.) for the transaction.

In various embodiments, a user may purchase electronic tickets and/or save electronic ticket information using a web client such as a web browser, web browser toolbar, and/or a desktop or mobile widget. For example, a user may save an electronic ticket and/or a hyperlink to a file associated with the electronic ticket in a subscriber account, in the web browser toolbar, and/or within a desktop or mobile widget. The user also may display information for and differentiate among purchased electronic tickets on a client device (e.g., PC or mobile device) via the web client.

The buyer may purchase one or more electronic tickets using a credit card or other source of funds or financial value linked to the subscriber account of the buyer. In one or more embodiments, the network-based system 310 may provide variable distribution and access control for purchased electronic tickers. For example, network-based system 310 may provide the buyer with various delivery options for receiving and/or delivering the purchased electronic tickets.

Network-based system 310 may allow the buyer to have the electronic tickets delivered to an e-mail address associated with the buyer. The buyer may access the e-mail account, display the electronic tickets, and print out paper copies of the electronic tickets. Each of the paper copies of the electronic tickets may include a bar code which can be scanned at the event venue to allow access.

Alternatively or additionally, the buyer may instruct the network-based system 310 to send an electronic ticket to a mobile device (e.g., mobile phone or PDA) associated with the buyer. For example, the buyer may receive the electronic ticket at the mobile device and display a bar code of the electronic ticket on a screen of the mobile device which may be scanned at the event venue to grant access. In some usage scenarios, the buyer may receive an SMS message sent to a mobile device that includes a link to a web page to render a ticket. In other usage scenarios, the buyer may receive an MMS message sent to a mobile device that includes an image of the ticket. When the buyer chooses delivery to a mobile device, the buyer also may receive the ticket via e-mail as a backup in case the buyer wants to print out a paper copy to bring to or use at the event venue. The buyer may receive a text message at the time of ticket purchase and, if the tickets are purchased more than a predetermined time before the event (e.g., two days before the event), a reminder text message just before (e.g., one day prior to) the event.

In various embodiments, when the buyer purchases electronic tickets using a credit card, the buyer may access the venue by swiping the credit card used to make the purchase at the event venue. Alternatively or additionally, the buyer may use a driver's license to validate the ticket at the event venue. In some implementations, only the buyer may use the credit card used to make the purchase or a driver's license as a means of entry at the event venue. It can be appreciated that in such implementations, the buyer may validate his/her ticket at the venue as well as validate other purchased tickets for other people who are present with the buyer at the time of entry into the event venue.

Network-based system 310 also may provide the buyer with various delivery options for splitting the distribution of a single order of multiple electronic tickets among one or more recipients in addition to and/or other than the buyer. In some cases, for example, a buyer may purchase multiple electronic tickets (e.g., block of four electronic tickets) at once in a single order. In such cases, the buyer may choose from the provided options for variably distributing one or more of the purchased electronic tickets and/or the underlying rights associated with one or more of the purchased electronic tickets to different end recipients using different delivery mechanisms.

In various implementations, when a buyer purchases more than one ticket, the buyer may choose to have the tickets delivered directly to one or more other recipients for use at the event venue. For example, when multiple tickets are purchased in one order, the buyer can decide how individual tickets will be delivered electronically to another person. Upon delivery, each ticket may be used by the recipient independently of the buyer arriving at the event so that the entire party does not need to be present to enter the event venue.

In one or more embodiments, network-based system 310 may allow the buyer to have an electronic ticket delivered to an e-mail address associated with a recipient other than the buyer. In such embodiments, the buyer may be presented with a user interface (e.g., web page) listing the purchased tickets (e.g., Ticket 1, Ticket 2, . . . Ticket N) and comprising input fields for providing the name of a recipient for each ticket. For example, the buyer may type the name of a recipient into a text entry box, select the name of a recipient from a contact list pull-down menu, and/or provide a name or other identifier for a recipient in any other suitable manner in accordance with the described embodiments.

The user interface presented to buyer may comprise input fields for selecting delivery options. For example, the buyer may select an electronic delivery option such as E-mail or Mobile Device from a pull-down menu for each ticket to specify how the ticket is to be delivered to the recipient. In some usage scenarios, the buyer may instruct network-based system 310 to send an electronic ticket to an e-mail address associated with the recipient. Alternatively or additionally, the buyer may instruct network-based system 310 to send an electronic ticket to a mobile device (e.g., mobile phone or PDA) associated with the recipient. The user interface presented to buyer also may comprise input fields for providing delivery information. For example, the buyer may input an e-mail address or mobile number for each recipient depending on whether the selected delivery option is e-mail or mobile device, respectively. When the buyer chooses to deliver one or more tickets to one or more other recipients, the buyer also may receive an e-mail for each ticket as a backup.

Network-based system 310 may coordinate the delivery of the electronic tickets to the one or more recipients designated by the buyer. In various implementations, network-based system 310 may be configured to deliver the electronic ticket information to the one or more recipients via e-mail, SMS message, MMS message, or other suitable delivery mechanism in accordance with the described embodiments. In some cases, the electronic ticket information may comprise a link to electronic ticket and/or the electronic ticket itself. When the electronic ticket information is delivered via e-mail, the recipient may access the e-mail account, display the electronic ticket, and print out a paper copy of the electronic ticket. The paper copy of the electronic ticket may include a bar code which can be scanned at the event venue to allow the recipient to access the event venue independently of the buyer.

When the electronic ticket information is delivered to a mobile device, the recipient may receive the electronic ticket at the mobile device and display a bar code of the electronic ticket on a screen of the mobile device which may be scanned at the event venue to grant access to the recipient independently of the buyer. In some usage scenarios, the recipient may receive an SMS message sent to a mobile device that includes a link to a web page to render a ticket. In other usage scenarios, the recipient may receive an MMS message sent to a mobile device that includes an image of the ticket. Each recipient and/or the buyer may receive a text message at the time of ticket purchase and, if the tickets are purchased more than a predetermined time before the event (e.g., two days before the event), a reminder text message just before (e.g., one day prior to) the event.

In various embodiments, the electronic ticket information may comprise event information and a request to accept the electronic ticket. In such embodiments, network-based system 310 may defer delivery of and/or access to the electronic ticket until the recipient confirms acceptance. The recipient may confirm acceptance by sending a reply message (e.g., e-mail message, text message), navigating to a web page, clicking a hyperlink, and/or in other suitable ways in accordance with the described embodiments. In some cases, for example, the recipient may be requested to access or create a subscriber account with network-based system 310 associated with the e-mail address or mobile device number provided by the buyer. If the recipient is a current subscriber, network-based system 310 may request the recipient to log in and accept the ticket. If the recipient is not a current subscriber, network-based system 310 may request the recipient to create a regular subscriber account or a temporary account with network-based system 310 for confirming acceptance.

In some implementations, the electronic ticket information may comprise a randomly-generated alphanumeric character string associated with the electronic ticket. For example, the recipient may be provided with a link comprising the character string that when clicked confirms acceptance of the electronic ticket. In some cases, the recipient may be provided with a link for navigating to a web page and inputting the character string into a text entry box to confirm acceptance of the electronic ticket. When delivery is to a mobile device, the recipient may be requested to send the character string in a reply text message to a number (e.g., common short code) associated with network-based system 310.

In various embodiments, network-based system 310 may allow the buyer to assign access rights for the electronic tickets. The mode of delivery and/or the underlying rights associated with an electronic ticket may be assigned to an end user by the buyer during the initial purchase. The buyer also may subsequently access his/her subscriber account to assign access rights to or remove access rights from one or more recipients. In this way, the buyer may control how many tickets will be used at the time the buyer enters the event venue.

In various implementations, network-based system 310 may communicate the access rights to an electronic ticketing system at the event venue to associate the electronic ticket with the buyer and/or one or more recipients. Access control at the event venue may be done by a scanner that will read a bar code contained on the ticket sent as described above. In some cases, the buyer may access the venue by swiping the credit card used to make the purchase at the event venue or a driver's license. The buyer also may validate other purchased tickets for other people who are present with the buyer at the time of entry into the event venue. Each ticket delivered to a recipient may be used independently of the buyer arriving at the event so that buyer does not need to be present for the recipient to enter the event venue.

As the purchaser, the buyer may retain ownership and control of the distribution of the tickets. Network-based system 310 allows the purchased tickets to be easily delivered to different end recipients and may be configured to distribute the purchased electronic tickets and/or the underlying rights associated with electronic tickets differently based on ownership. In various embodiments, the tickets and/or the underlying rights associated with the tickets may be distributed to different end recipients by network-based system 310 without affecting ownership, without relisting the tickets, and/or without requiring the recipients to purchase the tickets.

It can be appreciated that when ownership and control of the tickets is retained by the purchaser, the ability of a recipient to resell the tickets may be restricted. In some cases, however, the purchaser may choose to transfer complete ownership of an electronic ticket and/or the underlying rights associated with the electronic ticket to a recipient. In various embodiments, network-based system 310 may be configured to support and broker the transfer of electronic tickets from the purchaser to multiple end recipients as well as from a recipient to another individual (e.g., buyer or other recipient). For example, network-based system 310 may allow a recipient to list a received ticket for sale and may automatically handle the assignment of rights to a subsequent buyer when the ticket is purchased.

In cases where ownership and the underlying rights of an electronic ticket are transferred from the purchaser, network-based system 310 may communicate access rights to an electronic ticketing system at the event venue to associate the electronic ticket with a different individual (e.g., recipient or subsequent buyer). In some embodiments, network-based system 310 may instruct the ticketing system to activate new electronic tickets with new bar codes and to deactivate the original electronic tickets and original bar codes of the purchaser. The new electronic tickets can be delivered by network-based system 310 and/or the electronic ticketing system for use by the recipient or subsequent buyer.

Alternatively or additionally, network-based system 310 may instruct the ticketing system to associate new identification and/or authorization information (e.g., credit card, swipe card, password, pin code) with the electronic tickets and to deactivate identification and/or authorization information of the purchaser from the electronic tickets. Upon providing the required identification and/or authorization information to the electronic ticketing system, to a kiosk at the event venue, and/or to network-based system 310, the recipient or subsequent buyer can use the electronic ticket to access the event venue.

In one or more embodiments, network-based system 310 may allow the buyer to list one or more of the purchased tickets for resale. In such embodiments, a user interface (e.g., web page) may be presented that lists the purchased tickets (e.g., Ticket 1, Ticket 2, . . . Ticket N) and allows the buyer to select an option for publishing one or more of the tickets for resale via network-based system 310. For example, the buyer may select a resell option from a pull-down menu and/or otherwise identify a ticket for resale in any other suitable manner in accordance with the described embodiments. When published and resold via network-based system 310, the distribution (e.g., electronic delivery) of such tickets may be completely managed by network-based system 310. It can be appreciated that when network-based system 310 manages the distribution of tickets in this way, the need for the buyer to confirm the sale of the tickets may be eliminated.

As described above, network-based system 310 may communicate with users over one or more types of networks 308 via interfaces provided communications servers 320 and provide various services to users such as online marketplace and ticket fulfillment services via application servers 330 and databases 350. When servicing a user, network-based system 310 may present information to and/or receive information from the user in a variety of ways such by displaying and receiving information via user interfaces (e.g., web pages, interactive screens), sending and receiving messages (e.g., e-mail, IM, SMS, MMS, video message), placing and/or receiving telephone calls (e.g., landline, mobile, VoIP, IVR calls), and so forth. User interfaces also may be displayed to a user via one or more client programs 306 such as a web client (e.g., web browser, desktop or mobile widget, web browser toolbar) and/or a third-party application 316.

It is understood that the various servers discussed above with reference to FIG. 4 may be owned by a single entity, or by two or more separate entities. The various servers discussed above may also be operated by a single entity, or by two or more separate entities. In addition, although FIG. 4 illustrates the server separately, some of these servers may be integrated together, and some of the servers may also perform the functionalities of other servers.

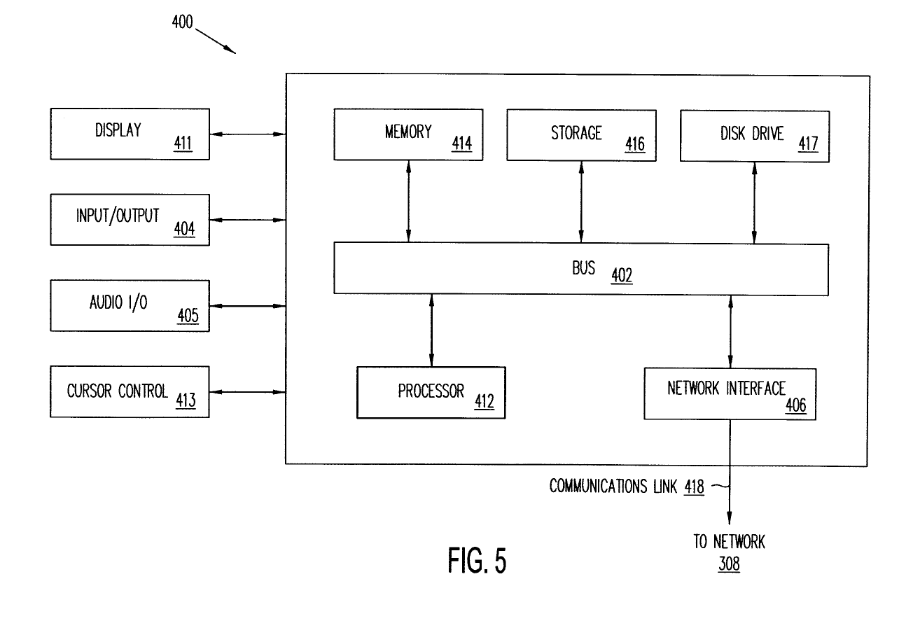

FIG. 5 is a block diagram of a computer system 400 suitable for implementing one or more devices of the present disclosure. In various implementations, a device may comprise a personal computing device (e.g., smart phone, a computing tablet, a personal computer, laptop, PDA, Bluetooth device, key FOB, badge, etc.) capable of communicating with the network. The ticket provider and/or a payment provider may utilize a network computing device (e.g., a network server) capable of communicating with the network. It should be appreciated that each of the devices utilized by users, ticket providers, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via a network. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

One aspect of the present disclosure involves a system. The system includes a computer memory storage component configured to store computer programming instructions; and a computer processor component operatively coupled to the computer memory storage component, wherein the computer processor component is configured to execute code to perform the following operations: receiving, from a user, a request to purchase a plurality of media items associated with an event; compiling the plurality of media items into a playlist, wherein the playlist arranges the media items according to a sequence in which they are presented during the event; and conducting an electronic purchasing transaction in which the playlist containing the media items is sold to the user.

Another aspect of the present disclosure involves an apparatus comprising a non-transitory, tangible machine-readable storage medium storing a computer program. The computer program contains machine-readable instructions that when executed electronically by processors, perform: receiving, from a user, a request to purchase a plurality of media items associated with an event; compiling the plurality of media items into a playlist, wherein the playlist arranges the media items according to a sequence in which they are presented during the event; and conducting an electronic purchasing transaction in which the playlist containing the media items is sold to the user.

Yet another aspect of the present disclosure involves a method. The method includes: receiving, from a user, a request to purchase a plurality of media items associated with an event; compiling, electronically by one or more processors, the plurality of media items into a playlist, wherein the playlist arranges the media items according to a sequence in which they are presented during the event; and conducting an electronic purchasing transaction in which the playlist containing the media items is sold to the user.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a computer memory storage component configured to store computer programming instructions; and
a computer processor component operatively coupled to the computer memory storage component, wherein the computer processor component is configured to execute code to perform the following operations:
receiving, from a user, a request to purchase a plurality of media items associated with an event;
compiling the plurality of media items into a playlist, wherein the playlist arranges the media items according to a sequence in which they are presented during the event; and
conducting an electronic purchasing transaction in which the playlist containing the media items is sold to the user.

2. The system of claim 1, wherein:
the event comprises a sporting event or an entertainment event; and
the media items comprise music or videos played at the event.

3. The system of claim 1, wherein the computer processor executes the code to perform the receiving the request by receiving a plurality of tags that each correspond to a respective one of the media items.

4. The system of claim 3, wherein the plurality of tags comprise a subset of the playlist, and wherein the computer processor executes the code to further perform: determining the playlist in its entirety based on the plurality of tags.

5. The system of claim 1, wherein the computer processor executes the code to perform the receiving the request by receiving identification information specifying the event in which the media items are played.

6. The system of claim 5, wherein the identification information comprises ticketing information for the event.

7. The system of claim 5, wherein the identification information comprises at least some of the following: time, location, name, and performers for the event.

8. An apparatus comprising a non-transitory, tangible machine-readable storage medium storing a computer program, wherein the computer program contains machine-readable instructions that when executed electronically by processors, perform:
receiving, from a user, a request to purchase a plurality of media items associated with an event;
compiling the plurality of media items into a playlist, wherein the playlist arranges the media items according to a sequence in which they are presented during the event; and
conducting an electronic purchasing transaction in which the playlist containing the media items is sold to the user.

9. The apparatus of claim 8, wherein:
the event comprises a sporting event or an entertainment event; and
the media items comprise music or videos played at the event.

10. The apparatus of claim 8, wherein the receiving the request comprises receiving a plurality of tags that each correspond to a respective one of the media items.

11. The apparatus of claim 10, wherein the plurality of tags comprise a subset of the playlist, and wherein the computer program executes the machine-readable instructions to further perform: determining the playlist in its entirety based on the plurality of tags.

12. The apparatus of claim 8, wherein the receiving the request comprises receiving identification information specifying the event in which the media items are played.

13. The apparatus of claim 12, wherein the identification information comprises ticketing information for the event.

14. The apparatus of claim 12, wherein the identification information comprises at least some of the following: time, location, name, and performers for the event.

15. A method, comprising:
receiving, from a user, a request to purchase a plurality of media items associated with an event;
compiling, electronically by one or more processors, the plurality of media items into a playlist, wherein the playlist arranges the media items according to a sequence in which they are presented during the event; and
conducting an electronic purchasing transaction in which the playlist containing the media items is sold to the user.

16. The method of claim 15, wherein:
the event comprises a sporting event or an entertainment event; and
the media items comprise music or videos played at the event.

17. The method of claim 15, wherein the receiving the request comprises receiving a plurality of tags that each correspond to a respective one of the media items.

18. The method of claim 17, wherein the plurality of tags comprise a subset of the playlist, and further comprising: determining the playlist in its entirety based on the plurality of tags.

19. The method of claim 15, wherein the receiving the request comprises receiving identification information specifying the event in which the media items are played.

20. The method of claim 19, wherein the receiving the identification information comprises receiving ticketing information for the event.

21. The method of claim 19, wherein the receiving the identification information comprises receiving at least some of the identification information regarding time, location, name, and performers for the event.
